(19) United States
(12) Patent Application Publication
(10) Pub. No.: US 2009/0138565 A1
(43) Pub. Date: May 28, 2009

(54) Method and System for Facilitating Content Analysis and Insertion

(76) Inventors: Gil Shiff, Tel Aviv (IL); Yoav Naveh, Tel Aviv (IL)

Correspondence Address: Professional Patent Solutions, P.O. BOX 654, HERZELIYA PITUACH, 46105, IL

(21) Appl. No.: 12/324,138

(22) Filed: Nov. 26, 2008

Related U.S. Application Data
(60) Provisional application No. 60/989,990, filed on Nov. 26, 2007.

(51) Int. Cl. G06F 15/16

(52) U.S. Cl. 709/206

(57) ABSTRACT

Disclosed is a system and method for facilitating the analysis and classification of content, and the selection and insertion of relevant content into messages. According to some embodiments of the present invention, there is provided a system and method that may allow for the selection and insertion of relevant content into messages in a computerized network.

### RELATED APPLICATIONS

The present application claims its priority date from U.S. Provisional patent application No. 60/989,990, filed on Nov. 26, 2007, which is hereby incorporated by reference in its entirety.

### FIELD OF THE INVENTION

The present invention generally relates to the field of content analysis. More specifically, the present invention relates to a system and method for content analysis, and/or its relevancy based insertion into messages.

### BACKGROUND OF THE INVENTION

One of key elements of the advertising market is displaying relevant and targeted content to the audience ads, thus increasing the probability of the user's interest in the ad and the overall revenues (in online advertising the interest is usually measured by the click-through-rate and conversation rate).

There is a worldwide tendency among Internet advertisers nowadays, to focus on user-interest related or user-profile matching advertising, thus increasing the probability of a high user interest in a presented advertisement or other content, and possibly the following of its link or differently further inquiring in regard to it and the goods or services it might represent. Leading such user focused website advertising tendencies include: contextual advertising: matching advertisements to search words and phrases (e.g. Google), matching according to the instant website's content (e.g. Adsense), and behavioral advertising: matching advertisements according to the user behavior.

Existing common contextual advertising solutions are mostly keywords-detection based. These solutions, often miss the context of the keywords in the text and generate irrelevant ads. This problem arises especially with the dynamic and concise textual user-generated content.

Existing common behavioral advertising solutions are mostly designed for selecting ads according to ads the user showed interest in at the past. These solutions, however, do not enable generating advanced “semantic user profiles”, and segments, by specific topics of interest the users show interest in (e.g., write about or read about), and do not enable detecting users segments and other characteristics (e.g. socio-demographic analysis, names analysis) by detecting their correlation with the various topics of interest.

Furthermore, despite the latest rapid growth of both the Internet advertising market, as well as the volume of use of a wide variety of electronic messages, a large part of the world's user selected or originated content, travelling or being presented on computerized networks remains free of appended content [e.g. advertisements]. Most of these user contents contain enough information within, as to enable selection of additional relevant content that has high probability of being of interest to the user.

The business model of most web-mail services (e.g. Gmail, Hotmail) and other User-Generated-Content platforms (e.g., forums, blogs) is based nowadays on profits from advertisements on these websites which users are exposed to, and from the sale of premium services. However, for delivered messages (e.g., e-mails, SMS, RSS feeds), there is currently no advertising profit from messages sent/received using pc/desktop software applications installed on user's machine (e.g. Outlook, Outlook Express, Eudora, desktop RSS readers) since their users are not exposed to any of the advertisements found on the server websites.

Messages automatic ‘enrichment’ solutions for branding or adding logos onto organization's messages are available, however, these are not intended nor can they be used and implemented for Web-Mail servers, ISP mail servers, mailing lists owners, blogs, forums, RSS feeds, SMS providers etc. Furthermore, the content they append is preselected with no correlation to the specific characteristics of each given message and its users (e.g. creator/sender/recipient). Fundamental technological differences exist between such organizational solutions and a solution that may be used for general selection and insertion of relevant content into messages. Such organizational solutions may focus on a small predetermined set of images or add-ons, they deal with a low diversity of message types, they are not adapted to perform “smart” semantic matching of different message contents and their relevant commercial advertisements, they do not enable Return On Investment (ROI) or User Interest Level data gathering and analysis, or utilize mechanisms essential for pricing different advertising or publicizing offers.

The standard classification methods based on “Bag-Of-Words” have some inherent drawbacks. Clearly remains a need for a system and method that also considers phrases, parts-of-speech, locations within the text, as well as other content characteristics within its classification process. Further, remains a need for system and method that enables the building of a large and accurate learning set—one of the largest challenges faced, when utilizing semantic classification algorithms.

### SUMMARY OF THE INVENTION

According to some embodiments of the present invention, there is provided a system and method for selecting and inserting content into messages in a computerized network.

According to some embodiments of the present invention, a proxy server may be adapted to intercept one or more data packets, which one or more data packets constitute a message or part of a message, traveling to or from user servers, PCs or any other computerized system.

According to some embodiments of the present invention, a content selection module may be adapted to analyze various characteristics of the message and accordingly select one or more contents from a content database, based on the level of their correlation to the analysis results. Rules may be constructed, as to compare an analyzed message's data structures to data structures of contents in the content database. A rule may supply indication of a match, no match and/or level of match for a given comparison.

According to some embodiments of the present invention, categories taxonomy may be used for correlation between the classified categorical context of messages and the potentially matching contents to be inserted into them, as well as in the construction of ‘user interest history’ based profiles. Potential content to be inserted may also be classified for a better matching.

According to some embodiments of the present invention, a content insertion module may be adapted to insert or append the one or more selected contents into/onto the message. Furthermore, the content insertion module may determine the form of insertion (e.g. within message's body, as an attachment) and its location (e.g. beginning of message, end of message) based on the message analysis and the characteristics of the selected content—to be inserted. Insertion of the one or more contents into the message may be executed in a way that does not hinder or affect its original pre-insertion informational values, context or its usability.

According to some embodiments of the present invention, the proxy server may, upon receipt of the content-containing message (or the original message if no content was inserted), proceed to forward it to its original pre-insertion destination.

According to some embodiments of the present invention, information pertaining to user's (e.g. recipient's) reactions (e.g. click/no click) to the inserted content may be forwarded to a redirect server, which redirect server may link/redirect or reference the user to additional inserted-content related data, for example, as a result of a positive user reaction to the inserted-content. The redirect server may be further adapted to send updates relating to said user-reactions to inserted-content, to a content and statistics server.

According to some embodiments of the present invention, content and statistics server may be adapted to provide statistics related to users' reaction (e.g. levels of interest) to certain content or to a group of contents as well as additional user and/or user's-message details (e.g. IP address, time of user click). This server may also conduct examinations in order to detect Click Frauds.

According to some embodiments of the present invention, a content management component may allow for the addition, removal and editing of contents, as well as the viewing of data and statistics related to them. This component may be used by content providers to define the message to be presented with each of their contents, and supply topics of interest and targeted key words that may relate to it or are to be associated with it. It may be further adapted to receive from commercial content providers, the maximal price they are willing to pay for interest in an advertisement (e.g. pay per click bid).

### BRIEF DESCRIPTION OF THE EXEMPLARY FIGURES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying exemplary figures in which:

FIG. 1 is a block diagram describing the main modules and relationships of an exemplary system for Facilitating Insertion of Relevant Content into Messages, in accordance with some embodiments of the present invention;

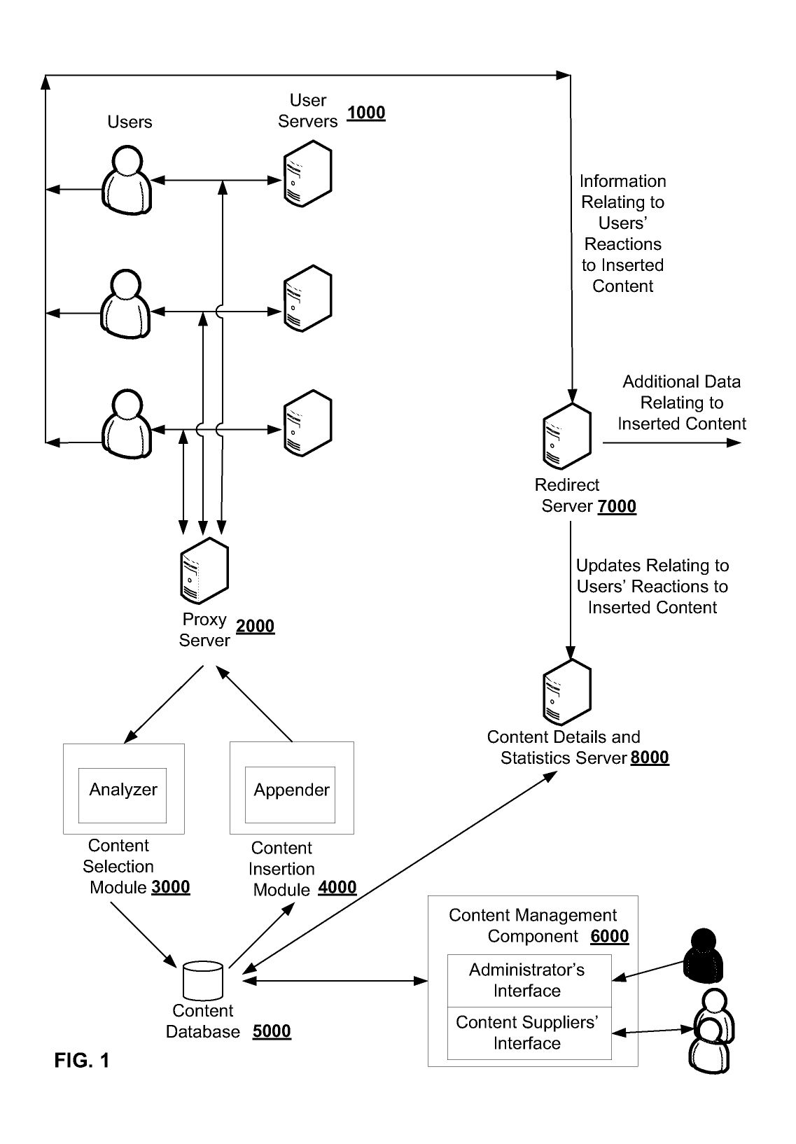

FIG. 2 is a flowchart describing the stages and steps of an exemplary method for Facilitating Insertion of Relevant Content into Messages, in accordance with some embodiments of the present invention;

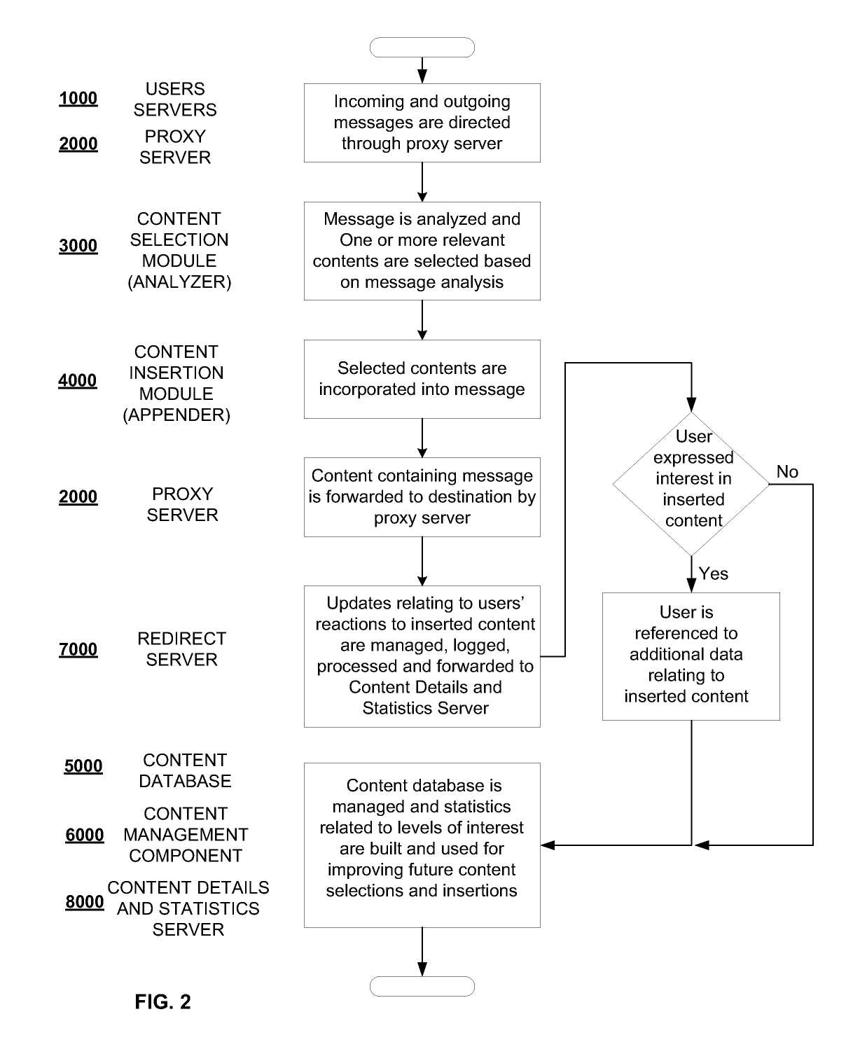

FIG. 3 is a flowchart describing the stages and steps of a possible logical learning flow in an exemplary system for Facilitating Insertion of Relevant Content into Messages, in accordance with some embodiments of the present invention;

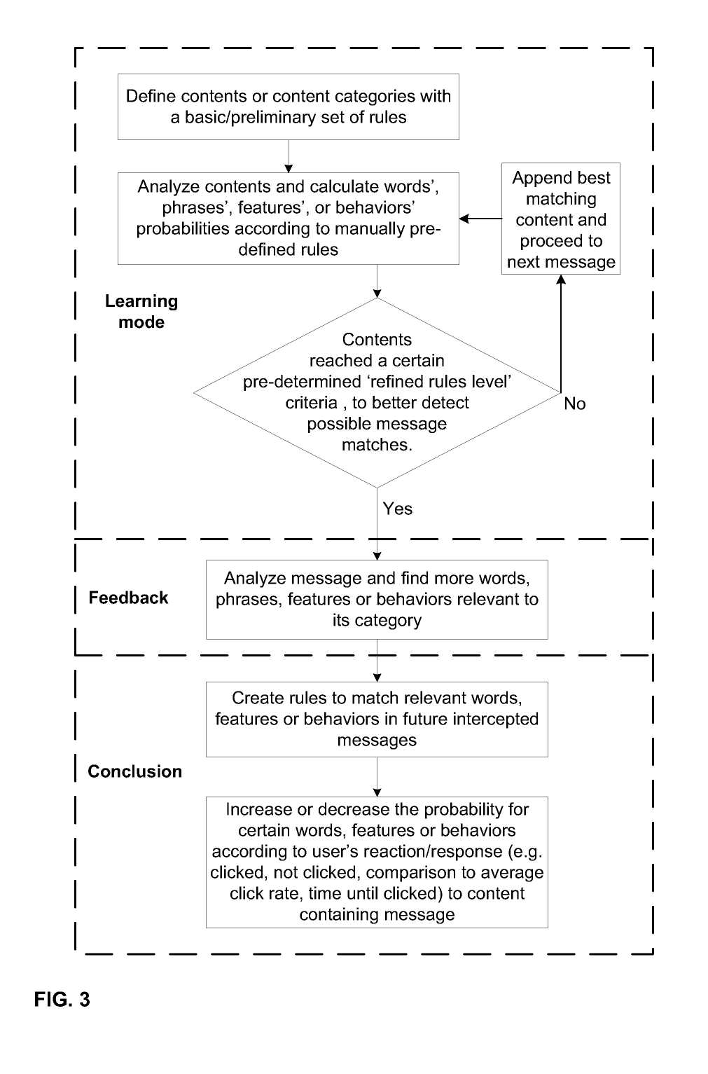

FIG. 4 is a flowchart presenting a set of exemplary steps, executed by a proxy server, in accordance with some embodiments of the present invention;

FIG. 5 is a flowchart presenting a set of exemplary steps, executed by a content selection module, in accordance with some embodiments of the present invention;

FIG. 6 is a flowchart presenting a set of exemplary steps, executed by an iterative learning mechanism, in accordance with some embodiments of the present invention;

FIG. 7 is a flowchart presenting a set of exemplary steps, executed by a phrase detector, in accordance with some embodiments of the present invention;

FIG. 8 is a flowchart presenting a set of exemplary steps, executed by a content classification algorithm, in accordance with some embodiments of the present invention;

FIG. 9 is a flowchart presenting a set of exemplary steps, used for “semantic user profiling”, in accordance with some embodiments of the present invention;

FIG. 10 is a flowchart presenting a set of exemplary steps, executed by a self improvement mechanism, in accordance with some embodiments of the present invention;

FIG. 11 is a flowchart presenting a set of exemplary steps, used for trends detection, in accordance with some embodiments of the present invention;

FIG. 12 is a flowchart presenting a set of exemplary steps, executed by a content insertion module, in accordance with some embodiments of the present invention; and

FIGS. 13A and 13B are screenshots of an e-mail (exemplary message) before and after an advertisement (exemplary content) has been appended to it, in accordance with some embodiments of the present invention.

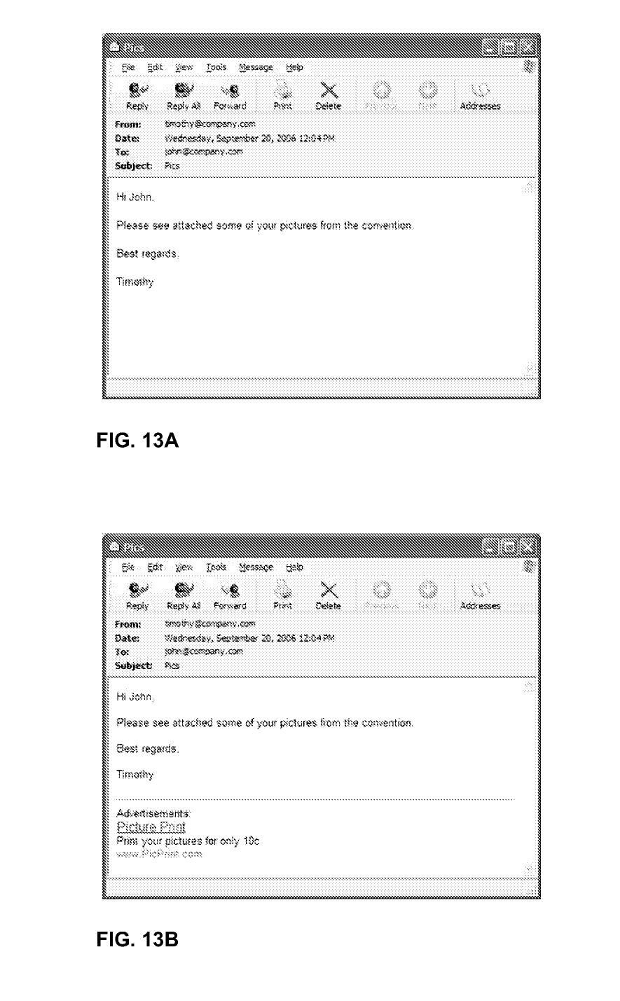

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. Such apparatus may be specially constructed for the desired purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

According to some embodiments of the present invention, there is provided a system and method for selecting and inserting content into messages in a computerized network.

According to some embodiments of the present invention, a proxy server (2000) may be adapted to intercept one or more data packets, which one or more data packets constitute a message or part of a message, traveling to or from user servers (1000), PCs or any other computerized system.

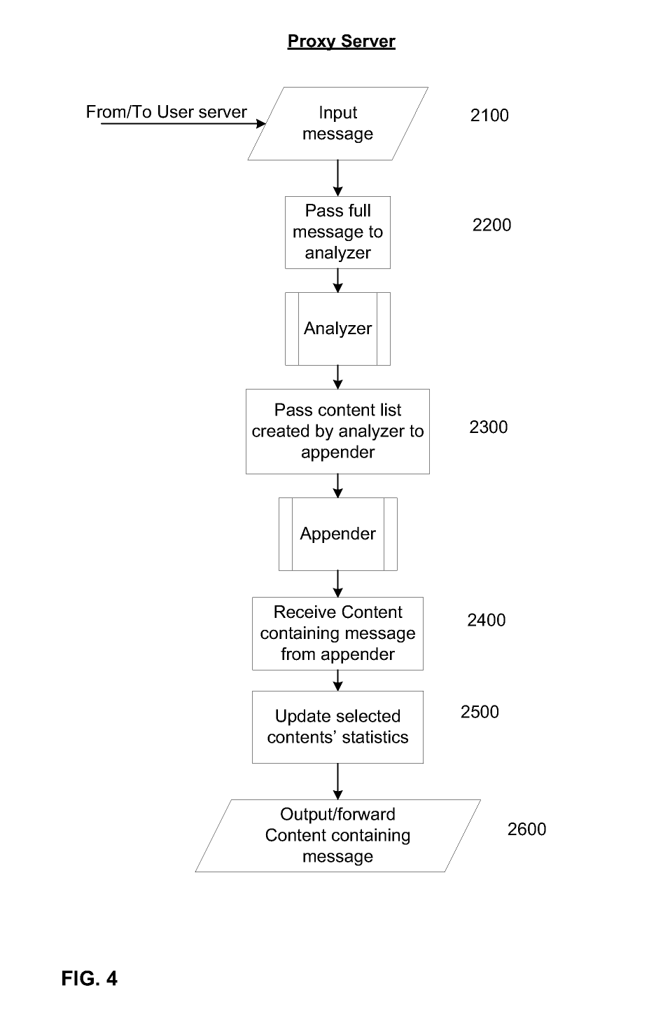

Turning now to FIG. 4, there is shown a flow chart presenting a set of exemplary steps, executed by a proxy server, in accordance with some embodiments of the present invention. The proxy server may intercept and input the message (2100) and pass it on to the content selection module's message-analyzer (2200) where its characteristics are analyzed and classified as elaborated hereinafter. The analysis based contents list created by the analyzer is then returned to the proxy server, which in turn may forward it to the content insertion module's content-appender (2300) where it will be inserted into the message.

The content containing message may then be returned to the proxy server (2400) where selected content statistics may be updated (2500). The proxy server may then output and forward the content containing message to its original, pre-interception destination.

According to some embodiments of the present invention, a content selection module (3000) may be adapted to analyze various characteristics of the message and accordingly select one or more contents from a content database (5000), based on the level of their correlation to the analysis results. Rules may be constructed, as to compare an analyzed message's data structures to data structures of contents in the content database. A rule may supply indication of a match, no match and/or level of match for a given comparison.

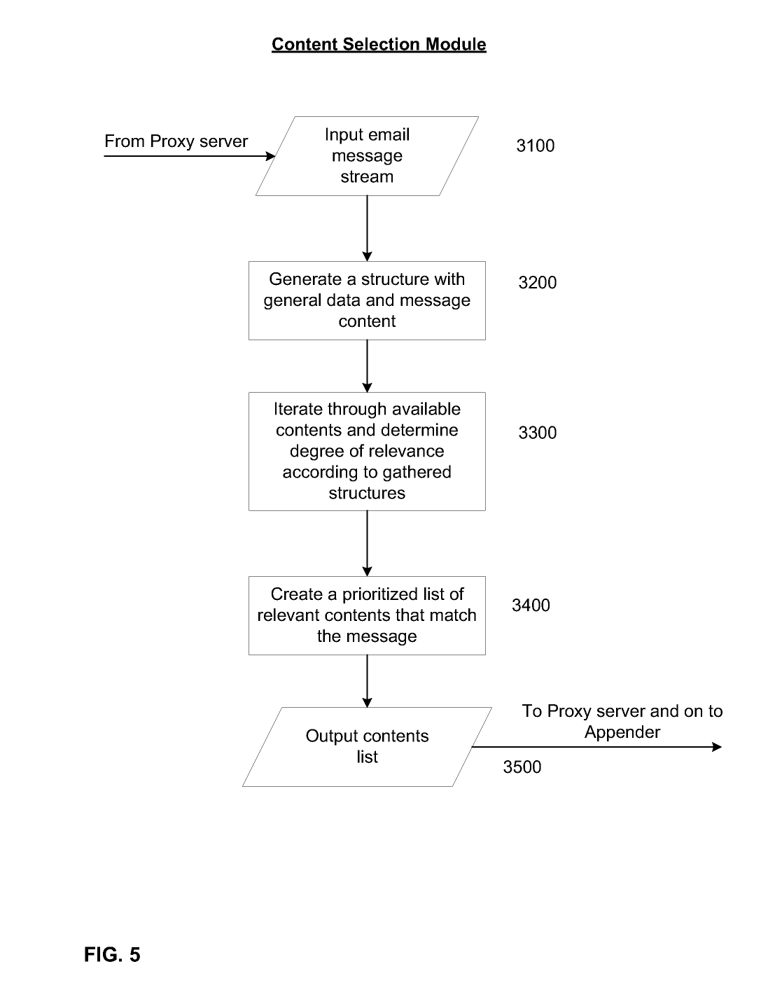

Turning now to FIG. 5, there is shown a flow chart presenting a set of exemplary steps, executed by a content selection module, in accordance with some embodiments of the present invention.

The content selection module may be adapted to input the message stream coming from the proxy server (3100), generate a structure with general data and message content (3200), Iterate through available contents and determine degree of relevance according to gathered structures (3300) and create and output a prioritized list of relevant contents that match the message (3400, 3500) by use of various analyzing and matching tools. Some of these tools along with their possible structures and main functionalities will now be further described.

According to some embodiments of the present invention, existing categorized data may be scanned and analyzed (e.g. by use of a web-crawler directed to categorized web-sites) for categories' names and their main characteristics (e.g. keywords), thus enabling the creation of a preliminary categories database. Using a given category's keywords, additional category related data sources may be searched for, from which yet additional characteristics and/or keywords may be derived. These categories may be used for correlation between the categorical context of messages and the potentially matching contents to be inserted into them, as well as in the construction of ‘user interest history’ based profiles.

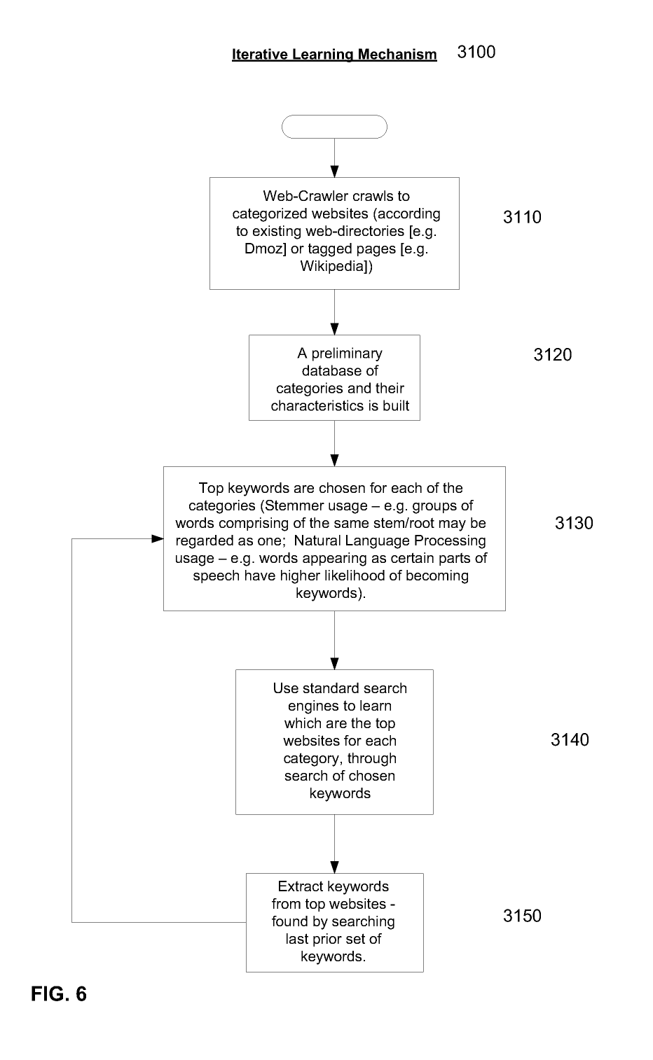

Turning now to FIG. 6, there is shown a flow chart presenting a set of exemplary steps, executed by an iterative learning mechanism, in accordance with some embodiments of the present invention. One or more web-crawlers may be adapted to crawl to categorized websites (according to existing web-directories [e.g. Dmoz] or tagged pages [e.g. Wikipedia]) (3110), automatically generate topics taxonomy, find correlation between the topics of the different data sources, and build a preliminary database of categories and their characteristics (3120).

Top keywords may then be chosen for each or some of the categories (3130). Keywords may be chosen in one of the following ways, by any possible combination of such ways or by use/combination of any other such ways know today or to devised in the future: manually, as the distinctive words of each category in the database, from the HTML keywords meta-tag of relevant sites for the category, from the entry value of tagged pages (e.g., Wikipedia). A stemmer may be used to group words comprising of the same stem/root, as to later allow them to be regarded as one. Natural Language Processing techniques may be used in order to allow words appearing as certain parts of speech, to have higher likelihood of becoming keywords.

Standard search engines may then be used to learn which additional websites are the top websites, for each of the categories, through execution of search queries containing the previously-chosen keywords in each of said categories (3140).

Additional keywords, from each of the categories' top websites may then be extracted (3150). These new keywords which may have been obtained from various data sources, as stated before, and may now go through the previously presented stemming and language processing processes (in 3130) and be used as the basis of the next round's search queries, thus raising the number relevant websites—only to produce further more keywords. Convergence may be achieved by reaching sufficient number of sites, or keywords, or database size, or classification verification score results.

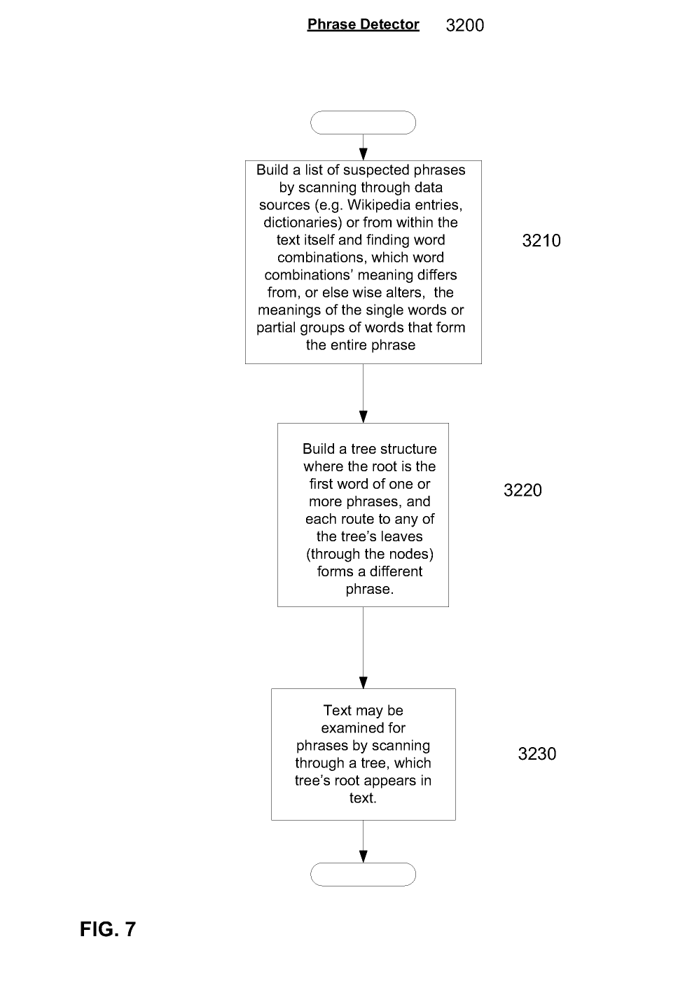

Turning now to FIG. 7, there is shown a flow chart presenting a set of exemplary steps, executed by a phrase detector, in accordance with some embodiments of the present invention.

Parallel category taxonomies may be created, each detecting a different vertical. Hence, the content may be analyzed for topics in different aspects. For example, a taxonomy for a main topic of interest, taxonomy for content type (e.g., news article, user-generate-content, promoting content), taxonomy for languages, taxonomy for time and places and so on. For example, first analysis would classify the topic of the message (e.g. Soccer), second analysis would attempt to detect the domineer of the user writing the post by use of slang, user profile, etc. (e.g. medium class) and a third analysis may attempt to detect the time frame the text refers to (example, if ‘snow’ or Christmas is mentioned that the text relates to December)

All these parallel levels of classification would allow the selection of the most appropriate content according to all attributes (e.g. ads for Christmas gifts)

A list of suspected phrases may be built by scanning through entries of data sources (e.g. Wikipedia entries, dictionaries), by finding the top occurrences of words combination in different data sources, thus detecting word combinations, which word combinations' meaning may differ from the meanings of the single words or partial groups of words that form the entire phrase (3210).

Using the generated phrase list, a tree structure may be built, wherein the root is one or more first words, of one or more phrases, and each route to any of the tree structure's leaves (through the nodes or directly to leaves when only 2 levels exist) forms a different phrase (3220).

Potential phrases in the text of a message being analyzed may now be searched for, by use of a Phrases Tokenizer. Category relevant phrases may be detected by scanning through the one or more phrase trees (3230) looking for those found by the Phrase Tokenizer. This may be done by searching for each of the trees' roots (i.e. words in the roots) in the text. If the root is found in the text, the following word in the text is searched for at all of the root's immediate sons. This process may repeat itself, until a route from the tree's root to one of its leaves comprises a set of words (e.g. root, leaf; root, node, leaf; root, node, node, leaf.) identical to a phrase that exists within the text, or until the text scan is completed.

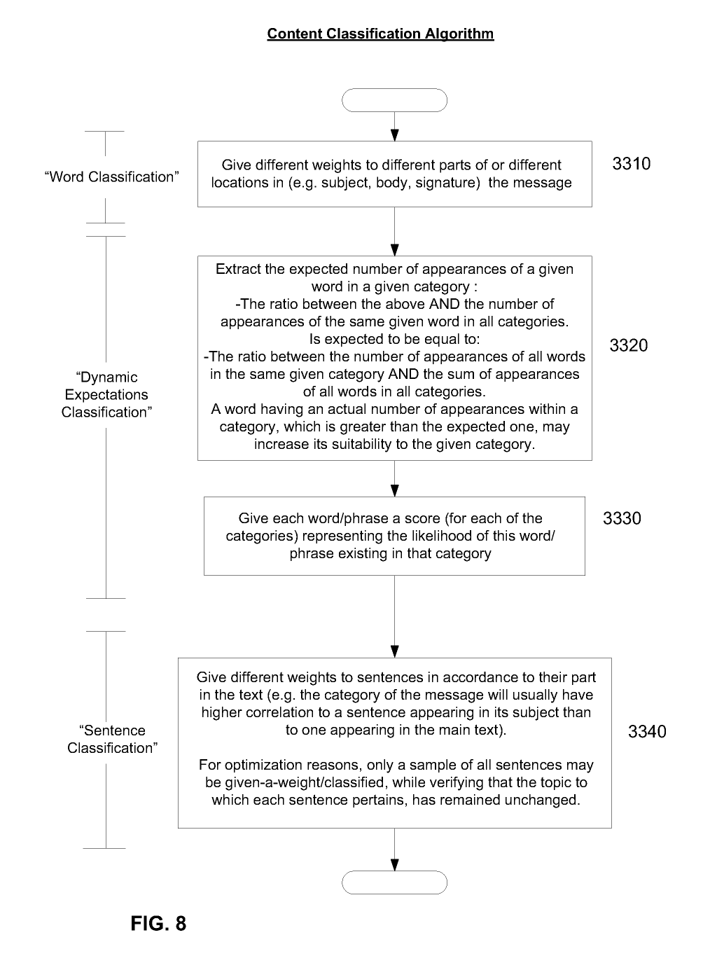

Turning now to FIG. 8, there is shown a flow chart presenting a set of exemplary steps, executed by a content classification algorithm, in accordance with some embodiments of the present invention.

Throughout the classification process different weights may be given to different words, in accordance to their part or location (e.g. subject, body, signature) within the text of a message (3310). For example, the category of the message may have higher correlation to a word appearing in its subject than to one appearing in the main text.

A Dynamic-Expectations-Classification algorithm may give a relevancy score for each topic in the categories taxonomy, by extracting the expected number of appearances of a given word in a given category by comparing the ratio between said ‘expected number of appearances of a given word in a given category’ (i.e. the unknown variable) AND ‘the number of appearances of the same given word in all categories’. Assuming a pre-defined distribution function the classification score may be calculated as the distance from the expected distribution; e.g., in an evenly distributed scenario it is expected to be equal to the ratio between the ‘number of appearances of all words in the same given category’ AND ‘the sum of appearances of all words in all categories’ (3320).

A word having an actual number of appearances within a category, which is greater than the expected one, may increase its suitability to the given category and vice versa. Each word or phrase may now be given a score for each of the categories, representing the likelihood of this word/phrase existing in that category (3330). The relevancy score of the content vs. each of the categories' taxonomy may be calculated by estimating the ‘distance’ between the expectancy and the actual content, by applying various mathematical functions, and by normalizing the results between predefined values or by applying functions such as Logit.

According to some embodiments of the present invention, a classification verification process may be used for calculating the success ratio on pre categorized data, and adjust the classification algorithm accordingly. For example, the verification process may include taking some of the pre-categorized data, which was not used in the learning set, classifying the content, calculating a success measure (e.g. F-Measure) and adjusting the classification variables to maximize it.

Using a Sentences-Tokenizer different weights may be given to different sentences (as previously shown for different words (in 3310)), in accordance to their part or location (e.g. subject, body, signature, different HTML meta-tags) within the text of a message. In order to optimize the process, merely a sample of all sentences may be given-a-weight/classified while concurrently verifying that the topic, to which each sentence pertains, has remained unchanged (3340).

These weights may be generated automatically, by using a pre-classified data source and finding the importance of each part of the message structure for the classification process (e.g. by classifying each part separately and finding the correlation with the real topic, or by finding the effect of each section by executing statistical regression containing the various section results vs. the known result).

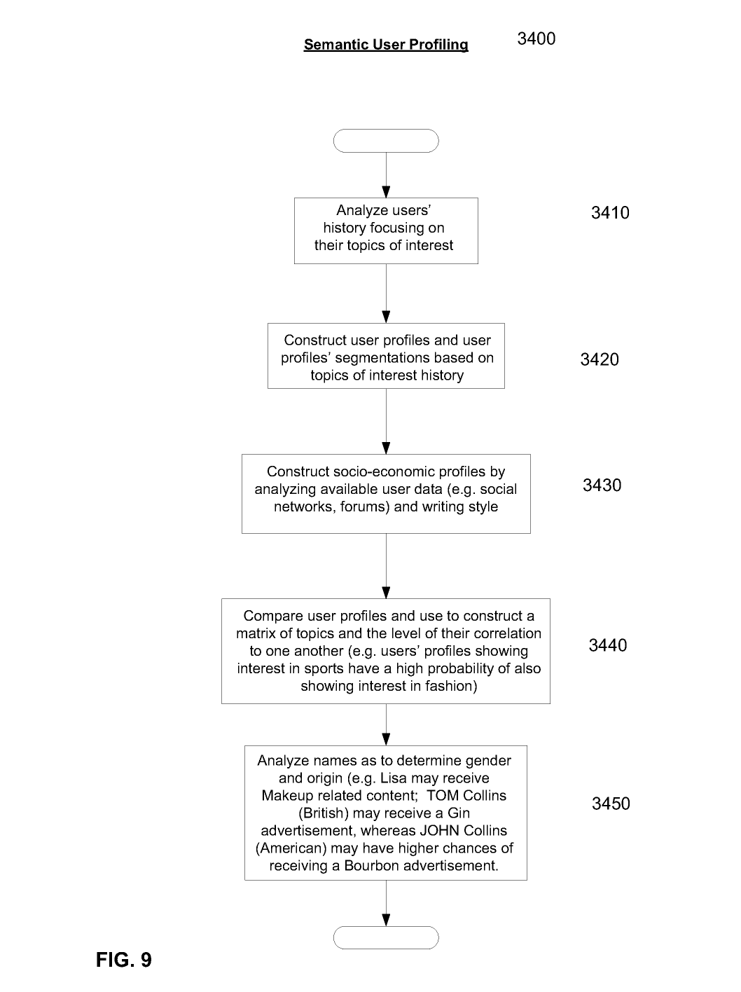

Turning now to FIG. 9, there is shown a flow chart presenting a set of exemplary steps, used for “semantic user profiling”, in accordance with some embodiments of the present invention.

The classification results may be used for generating “Semantic User Profiles”, by learning users' topics of interest (e.g. what type of content does he/she writes about, and which type of websites he's interested in). In addition, “semantic users profiles” for certain groups/segments of users having mutual topics of interest (i.e. have reacted substantially similarly to contents belonging to the same topic) may be detected and built (3420). Furthermore, preliminary users' profiles and detected segments may be generated by applying analysis of available user data (e.g. social networks, forums) and creating pre-defined roles and characteristics. Writing style and socio-economic data may be added to users' profiles (3430).

Feedback of user's reactions to inserted content may also be used to construct historical records that may be later analyzed and for improving the user profiles (3410).

Users' profiles may then be compared and used for construction of a matrix of topics and the level of their correlation to one another (e.g. users' profiles showing interest in sports have a high probability of also showing interest in fashion) (3440). This may create a higher probability for correct matching (i.e. one towards which the user will later react positively/express interest) of a certain X-type content to a certain Y-type content-containing message, knowing that high correlation of X-type content ‘lovers’ and Y-type content ‘lovers’ exists.

Another data source that may be used for profiling is users' names. The data regarding the users' names characteristics and correlation with various topics of interest may be generated by analyzing user-generated-content (e.g., social networks, forums, blogs, e-mails) comprising, either explicitly or by reference, its generator's (i.e. user) name. These may be analyzed as to determine certain characteristics such as gender, origin and religious background, by which better content match or content rule-out may be achieved (e.g. Lisa may receive Makeup related content; TOM Collins (British) may receive a Gin advertisement, whereas JOHN Collins (American) may have higher chances of receiving a Bourbon advertisement) (3450).

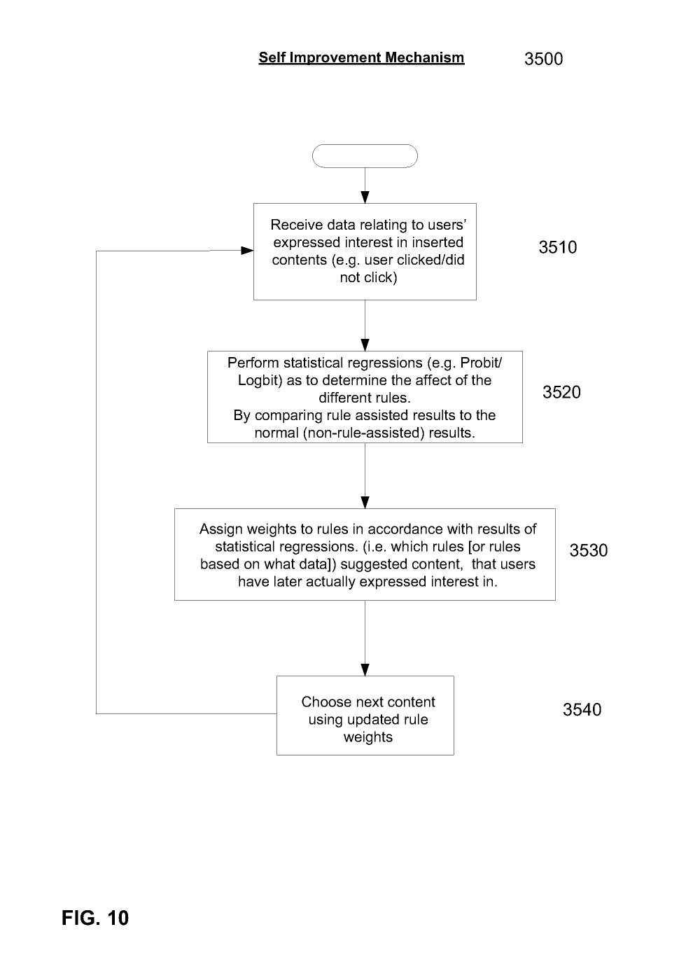

Turning now to FIG. 10, there is shown a flow chart presenting a set of exemplary steps, used by a self improvement mechanism, in accordance with some embodiments of the present invention.

Data relating to users' expressed interest in inserted contents (e.g. user clicked/did not click) is received (3510) from the redirect server. By performing statistical regression (e.g. Probit/Logbit) on different content-insertion decision rules (or group(s) of rules) impact, for example a comparison between rule-assisted and non-rule-assisted results may be executed and conclusions in regard to the positive, negative or no affect of these rules may be reached (3520). In addition, the user's expressed interest may be used for further improving the classification results (e.g., strengthening the classification database for the well performing classified results).

Rules may accordingly be assigned weights or their former weights may be updated (3530), as to increase or decrease their affect on future content-selection-decisions (3540).

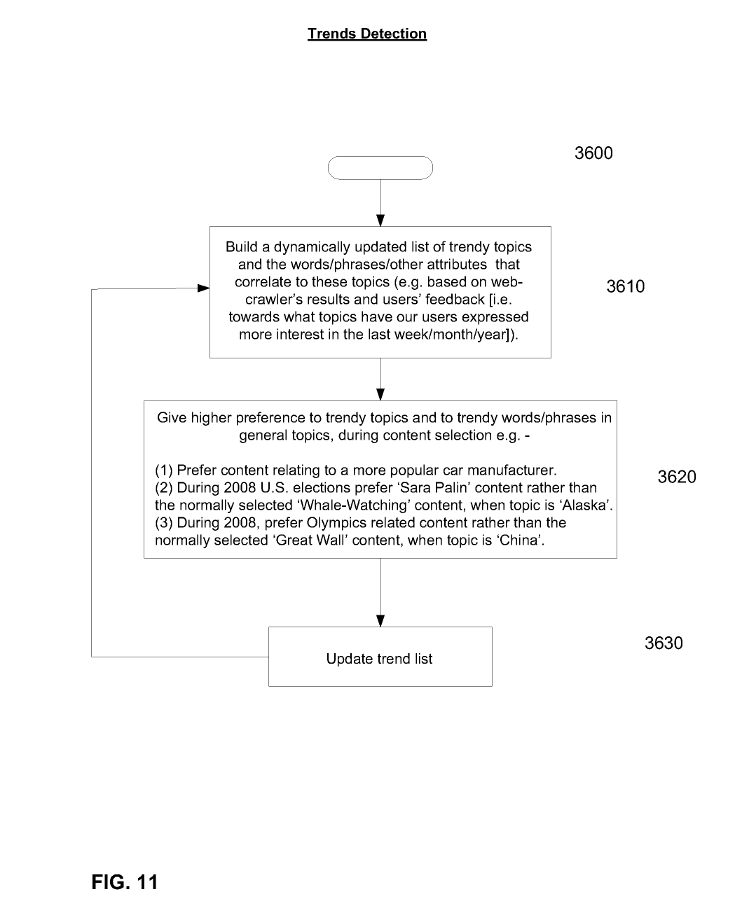

Turning now to FIG. 11, there is shown a flow chart presenting a set of exemplary steps, used for trends detection, in accordance with some embodiments of the present invention.

Primarily, a dynamically updated list of trendy topics and the words/phrases/other attributes that correlate to these topics may be built based on web-crawler's results and users' feedback (i.e. towards what topics have users expressed greater positive interest in the last period of time in comparison to corresponding time spans in the past) (3610).

Accordingly, higher preference may be given to trendy topics and/or categories. Furthermore, content containing trendy concepts, words or phrases may be preferred within the general topic's frame (e.g. after ‘Fashion’ was selected as the main topic from which content is to be chosen—Fashion content mentioning the color Blue may be preferred as this has been earlier determined to be the most trendy color this season) (3620). Newly received user reactions to inserted ‘trendy’ content may be used to further update the dynamic trend list.

According to some embodiments of the present invention, a content insertion module (4000) may be adapted to insert or append the one or more selected contents into/onto the message. Furthermore, the content insertion module (4000) may determine the form of insertion (e.g. within message's body, as an attachment) and its location (e.g. beginning of message, end of message) based on the message analysis and the characteristics of the selected content—to be inserted. Insertion of the one or more contents into the message may be executed in a way that does not hinder or affect its original pre-insertion informational values, context or its usability.

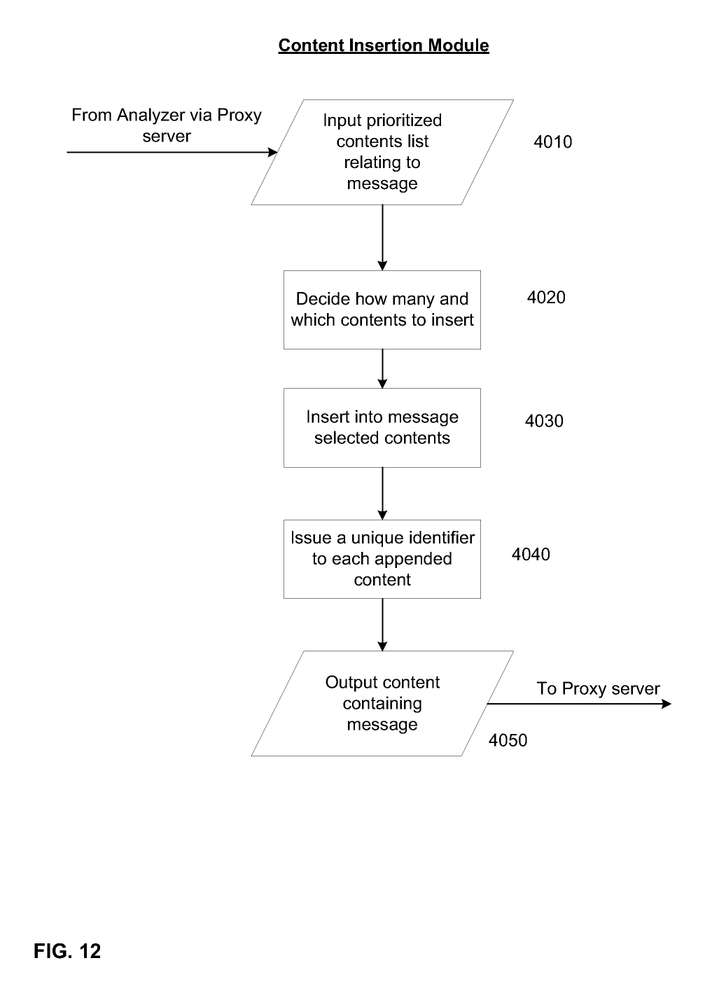

Turning now to FIG. 12, there is shown a flow chart presenting a set of exemplary steps, executed by a content insertion module, in accordance with some embodiments of the present invention.

Once an input of prioritized contents list relating to a message is received (4010) a decision in regard to how many and which contents to insert is made (4020), physical characteristics of the message and the suggested contents, structural constrains of both and exposure level of appended content, may be taken under consideration in the insertion decision. Once a decision has been reached, contents are inserted into the message (4030) and a unique identifier is issued for each of the inserted one or more contents. This identifier may later be used for corresponding user's reaction(s) to content-containing-message, to a particular given content appended (4040). Content containing message is then output and forwarded to the proxy server.

According to some embodiments of the present invention, the proxy server (2000), upon receipt of the content-containing message (or the original message if no content was inserted) from the content insertion module, may proceed to forward it to its original pre-insertion destination.

According to some embodiments of the present invention, information pertaining to user's (e.g. recipient's) reactions (e.g. click/no click) to the inserted content may be forwarded to a redirect server (7000), which redirect server (7000) may link/redirect or reference the user to additional inserted-content related data, for example, as a result of a positive user reaction to the inserted-content. The redirect server (7000) may be further adapted to send updates relating to said user-reactions to inserted-content, to a content and statistics server (8000) which updates may later be used to further train and improve the system's classification results and detection of new topics.

According to some embodiments of the present invention, a content and statistics server may be adapted to provide statistics related to users' reaction (e.g. levels of interest) to certain content or to a group of contents as well as additional user and/or user's-message details (e.g. IP address, time of user click). This server may also conduct examinations in order to detect Click Frauds.

According to some embodiments of the present invention, a content management component (6000) may allow for the addition, removal and editing of contents, as well as the viewing of data and statistics related to them. This component may be used by content providers to define the message to be presented with each of their contents, and supply rules, topics, key words and other characteristics that may relate to it or are to be associated with it. It may be further adapted to receive from commercial content providers, the maximal price they are willing to pay for interest in an advertisement (e.g. pay per click bid).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What claimed is:

1. A messaging system comprising:
a proxy server adapted to intercept a message sent from a sending messaging client application to a recipient messaging client application;
a content insertion module adapted to insert selected content into the intercepted message, which selected content is selected based on at least one message characteristic; and
wherein said proxy server is further adapted to forward the message, including inserted content, to the recipient messaging client application.

2. The system according to claim 1, wherein said message characteristic is selected from the group consisting of terms, images, message structure, topic profiles, message semantics, sender profile, recipient profile.

3. The system according to claim 2, further comprising a content selection module functionally associated with said insertion module.

4. The system according to claim 3, wherein the selection module is integral with the insertion module.

5. The system according to claim 3, wherein the inserted content includes at least one coded hyperlink which may be used by a user of the recipient messaging client application, wherein using the coded hyperlink initiates a network protocol based request including a code from the coded hyperlink.

6. The system according to claim 5, further comprising a redirect server adapted to: (1) receive a network based request initiated by a coded hyperlink, (2) update a statistics server based on the code within the request; and (3) redirect the request based on the code in the request.

7. The system according to claim 6, further comprising a statistics server functionally associated with a profile database and adapted to update a profile on the database in response to receiving codes associated with the reaction of a user of the recipient messaging client application to said inserted content.

8. A method for messaging comprising:
intercepting a message sent from a sending messaging client application to a recipient messaging client application;
inserting selected content into the intercepted message, which selected content is selected based on at least one message characteristic; and
forwarding the message, including inserted content, to the recipient messaging client application.

9. The method according to claim 8, wherein inserting further comprises selecting content based on a characteristic selected from the group consisting of terms, images, message structure, topic profiles, sender profile, recipient profile.

10. The method according to claim 9, wherein inserting further comprises including at least one coded hyperlink which may be used by a user of the recipient messaging client application, wherein using the coded hyperlink initiates a network protocol based request including a code from the coded hyperlink.

11. The method according to claim 10, further comprising (1) receiving a network based request initiated by a coded hyperlink; (2) updating a statistics server based on the code within the request; and (3) redirecting the request based on the code in the request.

12. The method according to claim 11, further comprising (1) receiving codes associated with the reaction of a user of the recipient messaging client application to said inserted content, from a statistics server; and (2) updating a user profile on a profile database in response.

13. The method according to claim 11, further comprising (1) receiving codes associated with the reaction of a user of the recipient messaging client application to said inserted content, from a statistics server; and (2) updating a topic's profile on a profile database in response.

14. A method for building a user semantic profile comprising:
classifying a user's topics of interest by analyzing preliminarily available user related data;
comparing said user's reaction to content relating to his topics of interest to other user's reaction to said content; and
defining groups of users reacting similarly to content of similar topics.

15. The method of claim 14, further comprising:
comparing user profiles' topics of interest;
constructing a matrix of topics; and
calculating the level of correlation between topics according to level of users' interest in them.

16. The method of claim 14, further comprising:
analyzing user's names;
estimating gender and origin of user; and
adjusting user's profiles likelihood of interest for topics based on their estimated gender or origin.

17. The method of claim 16, further comprising:
estimating age, income, place of residence and main language of user; and
adjusting user's profiles likelihood of interest for topics, wherein likelihood of interest is based on a group of user characteristics consisting of estimated age, estimated income, estimated place of residence and estimated main language.

18. A method for building a categories database comprising:
extracting data from existing categorized databases;
selecting key data for each of said categories;
searching for said key data at additional data sources;
extracting additional key data from data sources; and
researching for said additional key data.

19. The method of claim 18, further comprising:
altering the relative categorical weight of certain key data, in accordance with its location in the text.

20. The method of claim 18, further comprising:
Using Natural Language Processing techniques for altering the relative categorical weight of certain key data, in accordance with its grammatical characteristics.
